(19) United States
(12) Patent Application Publication
(10) Pub. No.: US 2006/0033407 A1
(43) Pub. Date: Feb. 16, 2006

(54) Combined casing assembly

(75) Inventor: Po-Kuei Su, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/914,158

(22) Filed: Aug. 10, 2004

(51) Int. Cl. F16B 12/00

(52) U.S. Cl. 312/111

(57) ABSTRACT

The present invention discloses a combined casing assembly capable of stacking several casings one on top of the other, which comprises at least one latch groove disposed on one surface of a casing; at least one installing section disposed on another surface at a position corresponding to the latch groove, and the installing section comprises a connecting hole, a latch and a protrusion disposed on the latch at one end corresponding to the connecting hole, and the protrusion being extended into the connecting hole, such that the latch is fixed onto the installing section as to connect a plurality of the casings of the foregoing structure by passing the latches through the latch grooves adjacent to the casing.

### FIELD OF THE INVENTION

The present invention relates to a casing assembly, more particularly to a combined casing assembly capable of stacking several casings one on top of the other.

### BACKGROUND OF THE INVENTION

In general, a stack method adopted by the traditional casing as disclosed in the R.O.C. Utility Model No. 187040 is a stacked casing assembly generally applied in network products. Please refer to FIG. 1. A convex arc section 11 is disposed at an appropriate position at the center of one surface of a casing 10; a plurality of latch grooves 12 is disposed on an edge of the convex arc section 11; a latch member 15 is disposed individually on opposite sides of the convex arc section 11 adjacent to the latch groove. Further, a protruded member 13 is disposed on the other side of the casing 10 at a position facing the back of one of the latch grooves 12; a footer 14 is disposed individually at an appropriate position corresponding to both ends on a plane of the casing 10 having the protruded member 13, and the convex arc section 11 can be accommodated precisely between two footers 14; a notch 16 is disposed on each corresponding side of the two footers 14, such that when a plurality of casings 10 having the same architecture is connected, the two latch members 15 and the two notches 16 disposed adjacent to the casing 10 are latched with each other, such that the two footers 14 of the casing 10 are coupled with the convex arc section 11 adjacent to the casing 10 and the protruded member 13 of the casing 10 is coupled with the latch groove 12 adjacent to the casing 10. Therefore, these casings 10 can be stacked one by one as a whole.

However, the prior-art method for manufacturing casings is too complicated and also uses more materials, and it thus increases the manufacturing costs. If the protruded member or latch is damaged, users cannot replace the components, and such arrangement definitely goes against the concept of pursuing simple structure, low cost and replaceable components.

### SUMMARY OF THE INVENTION

In view of the aforementioned stacked casing design, the manufacturing method not only is too complicated, but also uses more materials and increases the manufacturing costs. Furthermore, users cannot replace the plurality of latch members and protruded members. Therefore, the inventor of the present invention based on years of experience and professional knowledge on related field to conduct researches and experiments and finally invented a combined casing assembly in accordance with the invention.

The primary objective of the present invention is to provide a combined casing assembly which comprises at least one latch groove disposed on one surface of a casing; at least one installing section disposed on another surface at a position corresponding to the latch groove, and the installing section comprises a connecting hole, a latch and a protrusion disposed on the latch at one end corresponding to the connecting hole, and the protrusion being extended into the connecting hole, such that the latch is fixed onto the installing section as to connect a plurality of the casings of the foregoing structure by passing the latches through the latch grooves adjacent to the casing.

Another objective of the present invention is to install at least a fixture being disposed on one surface of the casing and at a position proximate to an edge, and a section of the fixture is exposed from that surface, and a fixing hole is disposed on the fixture and in the section of the surface where the fixture is exposed, and a fixing rod is disposed on that surface proximate to another edge and at a position corresponding to the fixture, so that when the casings of the same structure are stacked together, the fixing rod can be inserted into the fixing hole to connect the casings more securely.

### BRIEF DESCRIPTION OF THE DRAWINGS

FIG. 1 is a perspective view of a prior-art combined casing assembly.

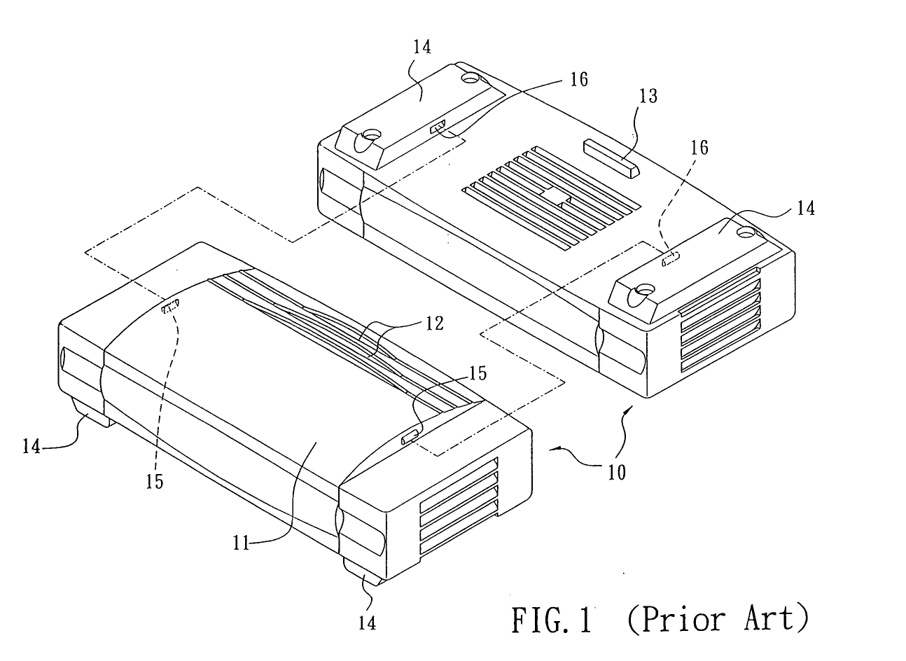

FIG. 2 is a view of the casing assembly according to the present invention.

FIG. 3 is a view of the casing combined with another adjacent casing according to the present invention.

FIG. 4 is an enlarged view of a part where two casings being connected according to the present invention.

### DETAILED DESCRIPTION OF THE PREFERRED EMBODIMENTS

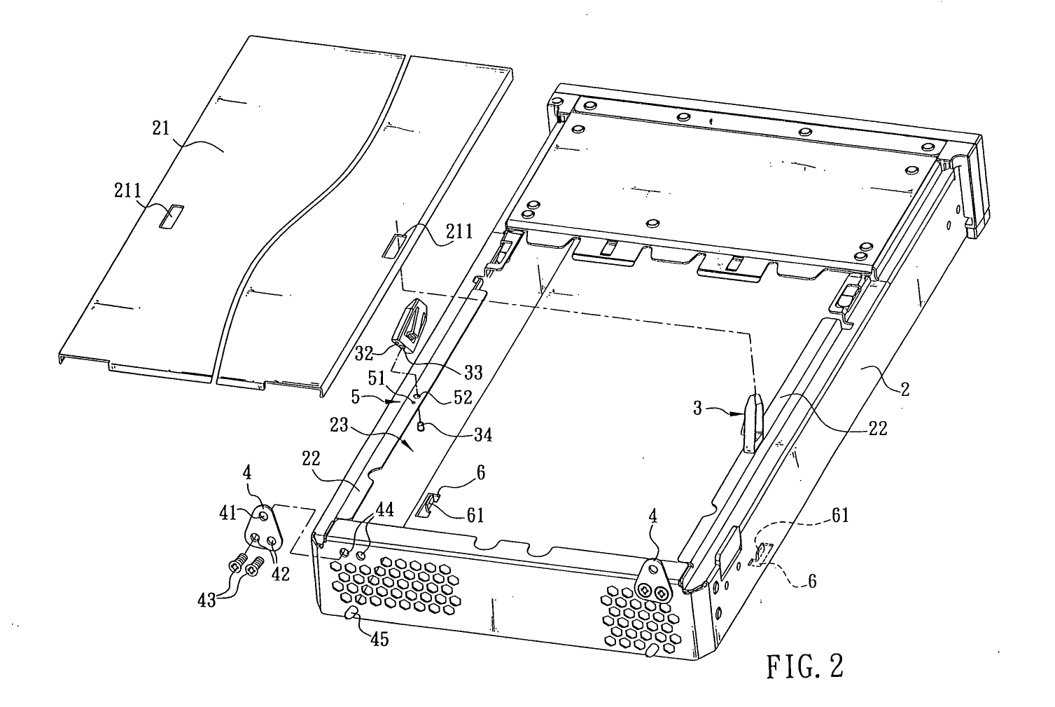

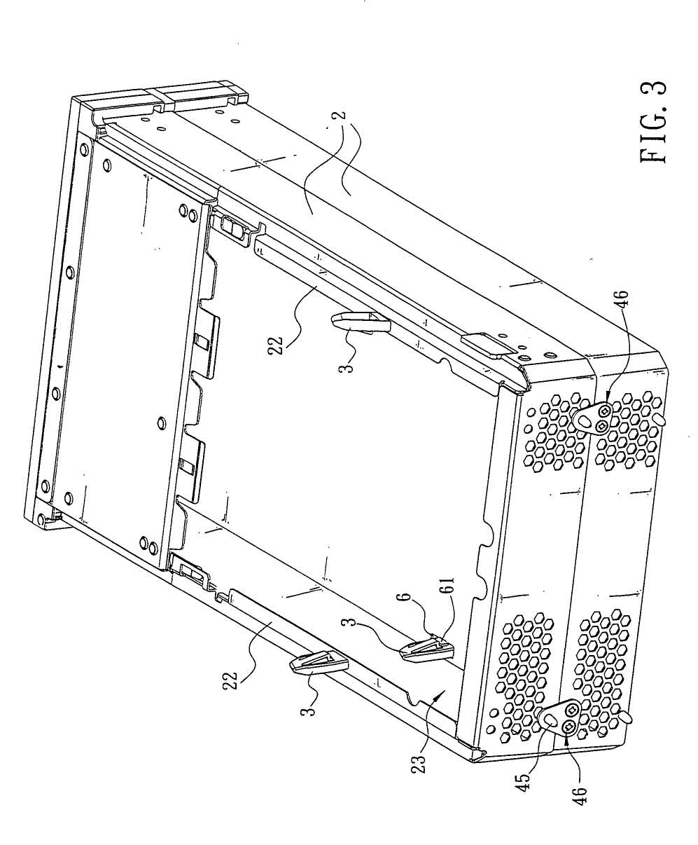

Please refer to FIG. 2 for the combined casing assembly according to the present invention, which comprises at least one latch groove 6 disposed on one side of a casing 2 and an installing section 5 disposed on the other side of the casing 2 and at a position corresponding to the latch groove 6. The installing section 5 comprises a latch 3 being installed thereon, at least one fixing rod 45 being disposed on one side of the casing 2, a fixture 4 being disposed on the other end of that surface and at a position corresponding to the fixing rod, a fixing hole 41 being disposed on a section of the fixture 4 and protruded from that surface, such that when a plurality of casings 2 of the same structure is stacked together as shown in FIG. 3, the fixing rod 45 can be inserted into the fixing hole 41 adjacent to the casings 2, and the latches 3 can be extended to each of the latch grooves 6 adjacent to the casing 2 as to secure the casings together and restrict each casing from displacing towards any direction.

Please refer to FIG. 2 for a preferred embodiment of the present invention. The casing 2 comprises an accommodating space 23 therein, a plurality of electronic components having different functions (not shown in the figure, such as a central processing unit (CPU), a memory and a hard disk drive) and at least one circuit board (not shown in the figure, such as a main board), so that the casing 2 can independently perform logic computing with the electronic components operated on the circuit board or can be connected with another adjacent casing 2 as shown in FIG. 3 for jointly performing the cluster computing. The cluster computing capability among each casing 2 can be stepped up or reduced by increasing or decreasing the quantity of connected casings 2 respectively.

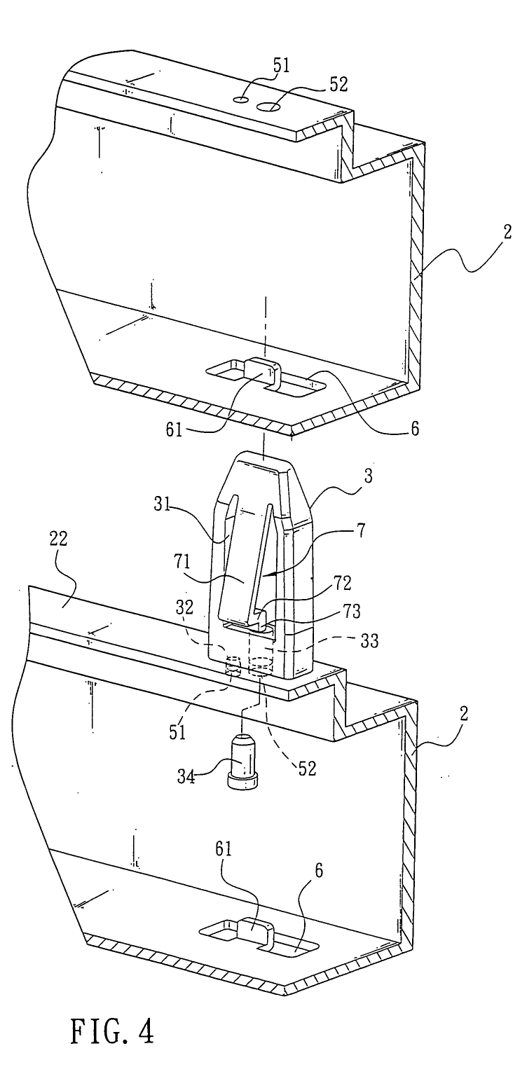

Please refer to FIG. 4 for the preferred embodiment. An open groove 31 is disposed at the center of the latch 3; a latch bracket 7 is disposed between two corresponding ends of the open groove 31; a protrusion 32 is protruded from on end of the latch 3; a latch hole 33 is disposed at an appropriate position adjacent to the protrusion 32. Further, the latch bracket 7 comprises an aslant section 71, a pressing section 72 and a connecting section 73; wherein an end of the aslant section 71 is coupled with an end of the open groove 31; the other end is extended and inclined to another end proximate to the open groove 31 and then coupled with an end of the pressing section 72; another end of the pressing section 72 is extended towards another end of the open groove 31 and then coupled with one end of the latch section 73; another end of the latch section 73 is coupled to another end of the open groove 31, or another end of the latch section 73 is coupled to another end of the adjacent open groove to define the latch bracket 7.

Please refer to FIG. 2 for the preferred embodiment. The casing 2 has a panel 21 on a surface of the installing section 5; the panel 21 can be detached from the casing 2 and the accommodating space 23 can be exposed; a support holder 22 is disposed on both corresponding sides of the adjacent panel 21 in the accommodating space 23, and the installing section 5 is disposed precisely on the two support holders 22. The installing section 5 comprises a connecting hole 51, and the connecting hole 51 is for accommodating the protrusion 32 as to couple the latch 3 with the installing section 5. Further, an opening 52 is disposed adjacent to the connecting hole and at an appropriate position of the latch hole 33, and the opening 52 can be secured together with the latch hole 33 by a same screw 34, such that the latches can be embedded securely onto the support holder 22. Further, an opening 211 is disposed on the panel 21 at an appropriate position corresponding to the installing section 5, so that when the latch 3 is coupled with the support holder 22, the panel 21 will be covered onto the casing 2 as to expose the latch 3 from the panel 21 through the corresponding opening 211.

Please refer to FIGS. 2, 3 and 4 again. The latch groove 6 has a block plate 61 on one side, such that when the latch 3 is extended into the corresponding latch groove 6, the aslant section 71 is precisely interfered by the block plate 61, and the aslant section 71 moves towards the opening 31. After the latch 3 is extended completely into the latch groove 6, the aslant section 71 resumes its original position by its resilience as to press the pressing section 72 onto the block plate 61 at an end facing the back of the latch groove 6, and the block plate 61 with its surface facing the latch groove 6 is attached onto the latch section 73 at a surface facing the latch groove 6, so that the latch 3 and the latch groove 6 are engaged as to connect two adjacent casings by coupling the latch 3 with the latch groove 6.

Further, if it is necessary to separate the casing 2 with the adjacent casing 2, a user just press the aslant section 71 towards the open groove 31 as to move the aslant section 71 and drive the latch section 72 away from the block plate 61, and thus releasing the latch between the latch bracket 7 and the block plate 61 and detaching the latch 3 from the latch groove 6 and further separating the casing 2 from the adjacent casing 2.

Please refer to FIG. 3 for the preferred embodiment. The fixture 4 is substantially in the shape of a triangular thin plate and has a fixing hole 41 at one corner (as shown in FIG. 2) and the fixing hole 41 is protruded and exposed out of the casing 2, so that the fixing rod 45 of the adjacent casing 2 can be inserted into the fixing hole 41 as to couple the casings 2.

Further, a lock section 46 is disposed on the other two corners of the fixture 4, and the lock section 46 can mount the fixture 4 onto the casing 2. Please refer to FIG. 2 again. The lock sections 46 are disposed on the other two corners and each lock section 46 has a fixing hole 42. Another two lock holes 44 are disposed on the end surface of the casing at a position corresponding to the fixture 4, so that the two lock holes 44 and the two fixing holes 42 are secured together by two screw components 43 as to secure the fixture 4 onto the casing 2.

While the invention has been described by means of specific embodiments, numerous modifications and variations could be made thereto by those skilled in the art without departing from the scope and spirit of the invention set forth in the claims.

What is claimed is:

1. A combined casing, comprising:
a casing, having at least one latch groove disposed on one surface and an installing section disposed on the other surface corresponding to said latch groove, and said installing section having a connecting hole;
at least one latch, being disposed on said installing section and having an open groove at the center of said latch and a latch bracket disposed on two corresponding end of said open groove, and said latch having a protrusion being disposed at an end of said latch and capable of being extended into said connecting hole as to fix said latch onto said installing section.

2. The combined casing assembly of claim 1, wherein said casing comprises a panel on said casing at a surface facing one surface of said installing section, and said panel is attached onto said casing for sheltering an accommodating space in said casing.

3. The combined casing assembly of claim 2, wherein said accommodating space comprises a support holder disposed on both corresponding sides adjacent to said panel, and said installing section is disposed on said two support holder, and said panel comprises an opening thereon at a position corresponding to said each installing section.

4. The combined casing assembly of claim 1, wherein said casing further comprises:
at least one fixture, being disposed on one surface of said casing and at a position proximate to one end of said casing, and a section of said fixture is exposed from said surface, and a fixing hole is disposed on said section on said surface having said fixture exposed from said surface;
at least one fixing rod, being disposed on the same surface with said fixture and at a position proximate to another end corresponding to said fixture and said fixing rod being inserted into said fixing holes.

5. The combined casing assembly of claim 1, wherein said latch bracket comprises:
an aslant section, having an end being coupled to an end of said open groove and the other end being inclined towards and extended into another end proximate to said open groove;
a pressing section, having an end being coupled to another end of said aslant section and another end of said pressing section being extended towards another end of said open groove and into another end adjacent to said open groove;
a connecting section, having one end coupled with another end of said pressing section and another end of said connecting section being coupled to another end of said open groove.

6. The combined casing assembly of claim 5; wherein said latch groove comprises a block plate disposed on one side of said latch groove.

7. The combined casing assembly of claim 1; wherein said latch comprises a latch hole disposed at a position adjacent to said protrusion and said casing comprises an opening disposed at a position adjacent to said connecting hole, such that said latch hole and said opening are coupled together by a screw.

8. The combined casing assembly of claim 4; wherein said fixture is substantially in the shape of a triangular thin plate and is flexible, and a section of said fixture protruded from said casing is a corner of said fixture and said fixing hole is disposed at said corner.

9. The combined casing assembly of claim 8; wherein said fixture has two other corner being coupled with said casing by a lock section thereon.

10. The combined casing assembly of claim 9; wherein said lock section disposed at said two other corners of said fixture individually have a fixing hole, and said casing on said surface comprises another two lock holes disposed at the positions corresponding to said fixtures, and said two lock holes and said two fixing holes are coupled together by a screw.
